(19) United States
(12) Patent Application Publication
(10) Pub. No.: US 2025/0253086 A1
(43) Pub. Date: Aug. 7, 2025

(54) MAGNETIC COMPONENT

(71) Applicant: Delta Electronics (Shanghai) CO., LTD., Shanghai (CN)

(72) Inventors: Haijun YANG, Shanghai (CN); Chunmei WANG, Shanghai (CN); Debao QUAN, Shanghai (CN); Xiaoqiang YU, Shanghai (CN)

(73) Assignee: Delta Electronics (Shanghai) CO., LTD., Shanghai (CN)

(21) Appl. No.: 19/026,749

(22) Filed: Jan. 17, 2025

(30) Foreign Application Priority Data
Feb. 1, 2024 (CN) 2024101476038

(51) Int. Cl. H01F 27/04; H01F 27/24; H01F 27/28; H01F 30/06

(52) U.S. Cl. CPC H01F 27/04; H01F 27/24; H01F 27/2828; H01F 30/06

(57) ABSTRACT

A magnetic component includes a first housing, a second housing, a magnetic core assembly, a pin and a high-current carrier. The first housing is in a hollow structure and is provided with a first pin socket and a second pin socket. The second housing is snap-fitted with the first housing to form an installation space, and is provided with a first socket and a second socket. The magnetic core assembly is arranged in the installation space, the pin is connected with a leading wire of the magnetic core assembly, and the pin is arranged in the first pin socket or the second pin socket. The high-current carrier passes through the second housing, and includes a connection section for connecting to a circuit board, and the high-current carrier is arranged in the first socket or the second socket.

### CROSS REFERENCE

The present application is based on and claims priority to Chinese Patent Application No. 2024101476038, filed on Feb. 1, 2024, the entire contents of which are incorporated herein by reference.

### TECHNICAL FIELD

The present disclosure relates to the technical field of electronic devices, and in particular to a magnetic component.

### BACKGROUND

With the widespread development of power electronics-based power conversion technologies in various application fields, the safety and low cost of power supply products are becoming increasingly important. As a low-cost current-sensing device in the power supply products, current transformers can relatively accurately monitor the leakage current in the circuit, which is of great significance to ensure the safety of equipment and personnel.

### SUMMARY

The present disclosure provides a magnetic component, including:
a first housing, wherein the first housing is in a hollow structure, and is provided with a first pin socket and a second pin socket, an extension direction of the first pin socket is perpendicular to an axis of the first housing, and an extension direction of the second pin socket is parallel to the axis of the first housing;
a second housing, snap-fitted with the first housing to form an installation space, and provided with a first socket and a second socket;
a magnetic core assembly, arranged in the installation space;
a pin, connected to a leading wire of the magnetic core assembly, arranged in the first pin socket, or arranged in the second pin socket; and
a high-current carrier, penetrated through the second housing, and including an connection section configured to be connected with a circuit board, wherein the high-current carrier is arranged in the first socket to make the connection section perpendicular to an axis of the installation space, or the high-current carrier is arranged in the second socket to make the connection section parallel to the axis of the installation space.

### BRIEF DESCRIPTION OF THE DRAWINGS

In order to more clearly illustrate technical solutions in the detailed description of the present disclosure or the prior art, the drawings required for use in the detailed description of the present disclosure or the prior art will be briefly introduced below. Apparently, the drawings in the following description are only some embodiments of the present disclosure. For those of ordinary skill in the art, other drawings may be obtained based on these drawings without paying any creative effort.

FIG. 1 is a schematic structural diagram of a magnetic component in a first installation form according to an embodiment of the present disclosure;

FIG. 2 is a schematic structural diagram of the magnetic component shown in FIG. 1 from another perspective;

FIG. 3 is an enlarged view of a structure at I in FIG. 2;

FIG. 4 is an exploded view of the magnetic component shown in FIG. 1;

FIG. 5 is a partial enlarged view of a structure at II in FIG. 4;

FIG. 6 is a partial enlarged view of a structure at III in FIG. 4;

FIG. 7 is a schematic structural diagram of a first housing in a magnetic component according to an embodiment of the present disclosure;

FIG. 8 is a schematic structural diagram of a second housing in a magnetic component according to an embodiment of the present disclosure;

FIG. 9 is a schematic structural diagram of cooperation between a first housing and a second housing in a magnetic component according to an embodiment of the present disclosure;

FIG. 10 is a schematic diagram of cooperation between the magnetic component shown in FIG. 1 and a circuit board;

FIG. 11 is another schematic structural diagram of a second housing in a magnetic component according to an embodiment of the present disclosure;

FIG. 12 is a schematic structural diagram of a magnetic component in a second installation form according to an embodiment of the present disclosure;

FIG. 13 is a schematic structural diagram of the magnetic component shown in FIG. 10 from another perspective;

FIG. 14 is a schematic structural diagram of a magnetic component in a third installation form according to an embodiment of the present disclosure; and

FIG. 15 is a schematic structural diagram of a magnetic component in a fourth installation form according to an embodiment of the present disclosure.

The following are the descriptions of the reference numerals:
1—a first housing; 11—body; 111—first groove; 1111—first protruding portion; 1112—first recessed portion; 12—insertion base; 121—first pin socket; 122—second pin socket; 123—first partition; 124—second partition; 125—accommodation groove; 2—second housing; 21—second groove; 211—first projection; 212—second projection; 213—third projection; 2131—first stop portion; 2132—second stop portion; 214—second recessed portion; 215—second protruding portion; 22—first socket; 23—second socket; 3—magnetic core assembly; 4—pin; 5—high-current carrier; 51—first connection section; 52—second connection section; 53—transverse section; 6—circuit board.

### DETAILED DESCRIPTION

The technical solution of the present disclosure will be described clearly and completely in conjunction with embodiments below. Obviously, the described embodiments are some of embodiments of the present disclosure, rather than all of the embodiments of the present disclosure. Based on the embodiments in the present disclosure, all other embodiments obtained by those of ordinary skill in the art without creative effort are within the protection scope of the present disclosure.

In the description of the present disclosure, it should be noted that, if the terms “center”, “upper”, “lower”, “left”, “right”, “vertical”, “horizontal”, “inner”, “outer”, etc. appear, an orientation or position relationship indicated is based on an orientation or position relationship shown in the accompanying drawings, which is only for the convenience of describing the present disclosure and simplifying the description, and does not indicate or imply that the device or element referred to must have a specific orientation, be constructed and operated in a specific orientation, and therefore cannot be understood as a limitation of the present disclosure. In addition, if the terms “first”, “second”, “third” appear, they are only used for descriptive purposes and cannot be understood as indicating or implying relative importance.

In the description of the present disclosure, it should be noted that, unless otherwise clearly specified and limited, the terms “installed”, “connected to”, and “connected with” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal communication of two components. For those of ordinary skill in the art, the specific meanings of the above terms in the present disclosure can be understood according to specific circumstances.

As described above, with the widespread development of power electronics-based power conversion technologies in various application fields, the safety and low cost of power supply products are becoming increasingly important. As a low-cost current-sensing device in the power supply products, current transformers can relatively accurately monitor the leakage current in the circuit, which is of great significance to ensure the safety of equipment and personnel.

The current transformers are usually installed according to the spatial layout of power converters. However, since the power converters have different sizes and structures, the current transformers have at least two installation forms: horizontal and vertical, which requires separate mold according to different installation forms, resulting in a large number of molds, extended development periods and increased development costs.

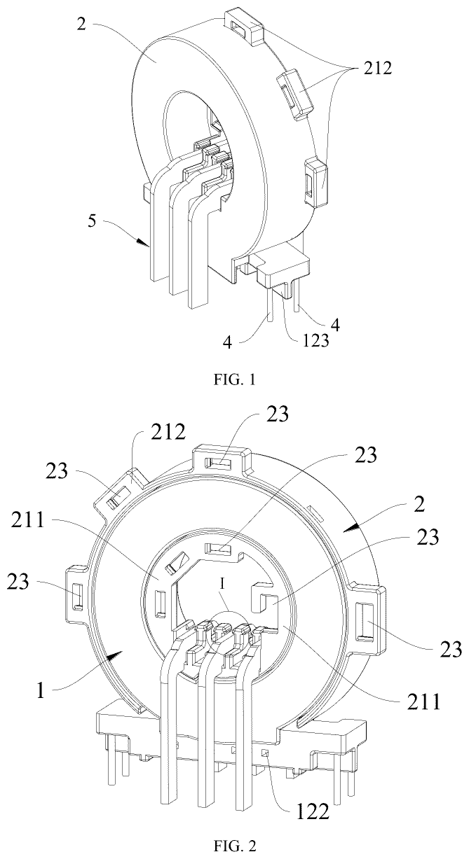

Referring to FIGS. 1 to 15, embodiments of the present disclosure provide a magnetic component, including a first housing 1, a second housing 2, a magnetic core assembly 3, a pin 4 and a high-current carrier 5. The first housing 1 is in a hollow structure. Specifically, the first housing 1 may be in a ring hollow shape, a square hollow shape, a run-way hollow shape, etc. The first housing 1 is provided with a first pin socket 121 and a second pin socket 122, an extension direction of the first pin socket 121 is perpendicular to an axis of the first housing 1, and an extension direction of the second pin socket 122 is parallel to the axis of the first housing 1. The second housing 2 is snap-fitted with the first housing 1 to form an installation space, and the second housing 2 is provided with a first socket 22 and a second socket 23. The magnetic core assembly 3 is arranged in the installation space. The pin 4 is connected to a leading wire of the magnetic core assembly 3, and the pin 4 is arranged in the first pin socket 121, or the pin 4 is arranged in the second pin socket 122. The high-current carrier 5 passes through the second housing 2, and the high-current carrier 5 includes an connection section configured to be connected with a circuit board 6. The high-current carrier 5 is arranged in the first socket 22, so that the connection section is perpendicular to an axis of the installation space, or the high-current carrier 5 is arranged in the second socket 23, so that the connection section is parallel to the axis of the installation space.

In the magnetic component provided by embodiments of the present disclosure, since the first housing 1 is provided with the first pin socket 121 and the second pin socket 122, and the second housing 2 is provided with the first socket 22 and the second socket 23, installation positions of the pin 4 and the high-current carrier 5 can be selected according to the actual application, thereby realizing different installation forms. For example, the pin 4 can be inserted into the first pin socket 121, and the high-current carrier 5 can be installed in the first socket 22, or the pin 4 can be inserted into the second pin socket 122, and the high-current carrier 5 can be installed in the second socket 23, or the pin 4 can be inserted into the second pin socket 122, and the high-current carrier 5 can be installed in the first socket 22, or the pin 4 can be inserted into the first pin socket 121, and the high-current carrier 5 can be installed in the second socket 23. Therefore, the magnetic component provided by embodiments of the present disclosure can reduce the number of molds, shorten the development periods, and thus reduce the development costs.

The magnetic component provided in embodiments of the present disclosure may be a current transformer, which is configured to acquire and detect a leakage current of a power converter.

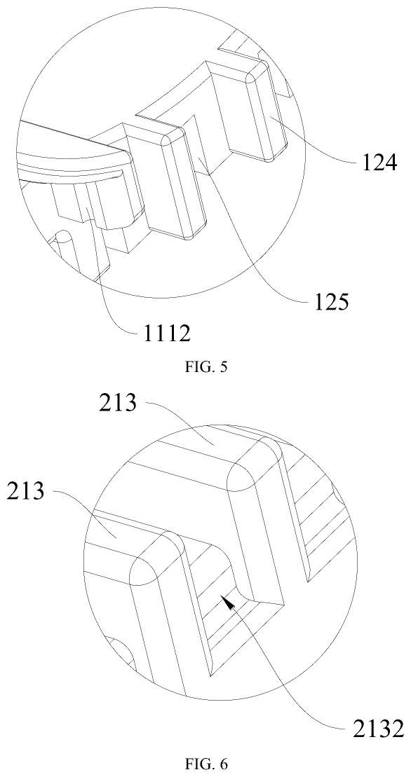

In an embodiment, as shown in FIG. 4, the first housing 1 includes a body 11 and an insertion base 12 integrally formed with an outer wall of the body 11, and the first pin socket 121 and the second pin socket 122 are both arranged in the insertion base 12.

Referring to FIGS. 4 and 6, the first housing 1 is provided with a first groove 111, specifically, the first groove 111 is arranged in the body 11, and the magnetic core assembly 3 is arranged in the first groove 111. In embodiments of the present disclosure, the magnetic core assembly 3 includes a magnetic core and a coil winding wound on the magnetic core, and the leading wire of the coil winding is connected to the pin 4.

In embodiments of the present disclosure, an outer wall of the first groove 111 is provided with a snap-fitting portion; the second housing 2 is provided with a second groove 21, and an outer wall of the second groove 21 is provided with a snap-fitting mating portion, which cooperates with the snap-fitting portion to make two groove walls of the first groove 111 be limited in the second groove 21 in a fixed manner.

For example, during assembly, the magnetic core assembly 3 is installed in the first groove 111, and then the second housing 2 is snapped onto the outside of the first housing 1. In this case, the magnetic core assembly 3 is limited in a closed installation space surrounded by the first groove 111 and the second housing 2.

In some embodiments, the snap-fitting portion is a protruding portion, and the snap-fitting mating portion is a recessed portion.

In some other embodiments, the snap-fitting portion is a recessed portion, and the snap-fitting mating portion is a protruding portion.

Alternatively, the snap-fitting portion may include a combination of the protruding portion and the recessed portion, and correspondingly, the snap-fitting mating portion includes the recessed portion and the protruding portion.

For example, referring to FIGS. 4, 8 and 9, the snap-fitting portion includes a first protruding portion 1111 and a first recessed portion 1112, and the snap-fitting mating portion includes a second recessed portion 214 and a second protruding portion 215. The second recessed portion 214 is snapped with the first protruding portion 1111, and the second protruding portion 215 is snapped with the first recessed portion 1112, thereby achieving a fixed connection between the first housing 1 and the second housing 2, and ensuring that the magnetic core assembly 3 is located in the installation space.

In an embodiment, the first protruding portion 1111 is a bump arranged on a side of the outer wall of the first groove 111 close to a groove bottom, and the second recessed portion 214 is a locking hole arranged on an outer wall of the second groove 211.

For example, as shown in FIG. 4, the number of first protruding portions 1111 may be one, a cross-sectional shape of the first protruding portion 1111 along a radial direction of the first groove 111 may be substantially a right-angled trapezoid, and the locking hole may be a through hole, and a shape of the locking hole may be substantially a rectangle.

In an embodiment, the second protruding portion 215 is a rib arranged on the outer wall of the second groove 21, and the first recessed portion 1112 is a locking groove arranged on a side of the outer wall of the first groove 111 close to the groove opening.

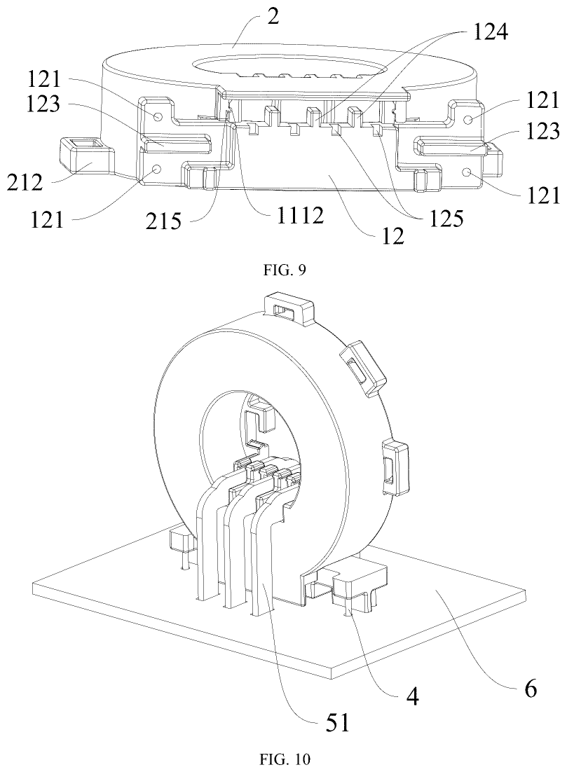

For example, as shown in FIG. 9, the number of first recessed portions 1112 may be two, and the first recessed portions 1112 may be arc-shaped grooves, and groove openings of the two arc-shaped grooves are arranged opposite to each other; the second protruding portion 215 may be an arc-shaped rib, and the number of second protrusions 215 may be two, which are assembled and matched with the two first recessed portions 1112 in a one-to-one correspondence.

In an embodiment, the first housing 1 and the second housing 2 are respectively formed by injection molding.

The first housing 1 and the second housing 2 may both be made of plastic.

In an embodiment, the second housing 2 is fitted over the outside of the first housing 1; the second housing 2 is generally hollow in structure, and an inside surface of the second housing 2 is provided with a first projection 211. The number of second sockets 23 is multiple, and at least part of the second sockets 23 is arranged at the first projection 211.

For example, as shown in FIG. 2, the number of first projections 211 is multiple. In general, during mold forming, an opening is required to inject an injection molding material, and one of the first projections 211 has a notch. When the high-current carrier 5 on the right side of FIG. 2 is installed in the first socket 22, the notch can avoid the high-current carrier 5 for easy assembly.

In some embodiments, referring to FIGS. 1 to 10, the pin 4 is arranged in the first pin socket 121, and the high-current carrier 5 is installed in the first socket 22, and a vertical magnetic component is formed in this case.

Referring to FIGS. 4, 6 and 8, an inside surface of the second housing 2 is provided with a plurality of third projections 213 spaced apart in a direction perpendicular to an axis of the second housing 2, and the space between two adjacent third projections 213 forms the first socket 22.

It should be understood that when the number of high-current carriers 5 is more than two, the number of first sockets 22 is usually greater than the number of high-current carriers 5 to ensure that there is a sufficient gap between the multiple high-current carriers 5.

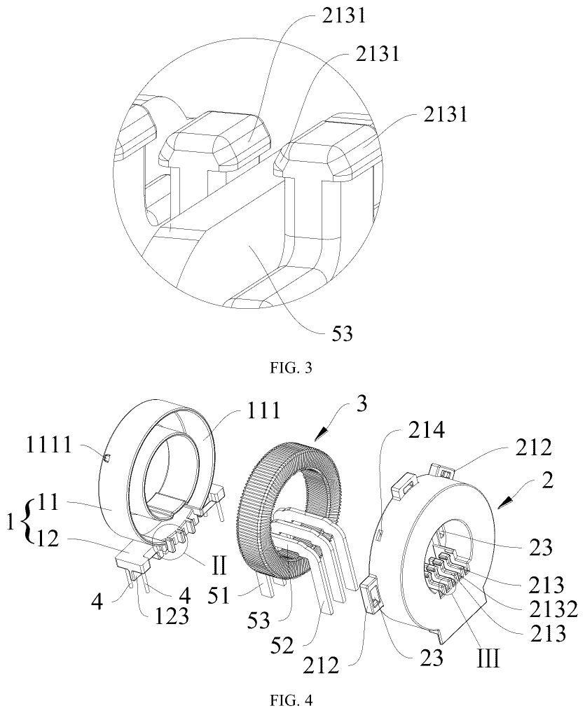

As shown in FIGS. 3 and 4, the high-current carrier 5 further includes a transverse section 53 connected to the connection section and snapped in the first socket 22. Surfaces of two adjacent third projections 213 close to each other are each provided with a first stop portion 2131, and the spacing between two adjacent first stop portions 2131 is smaller than a width of the transverse section 53. The first stop portion 2131 can abut against the transverse section 53 to limit movement of the high-current carrier 5 in a direction perpendicular to the axis of the second housing 2.

As shown in FIG. 4, the connection section includes a first connection section 51 and a second connection section 52. The first connection section 51 is connected to an end of the transverse section 53, and the second connection section 52 is connected to the other end of the transverse section 53. For example, the first connection section 51, the second connection section 52 and the transverse section 53 are integrally formed, and the formed high-current carrier 5 has a U-shaped flat plate structure, which is conducive to arranging multiple high-current carriers 5 while reducing the radial size of the second housing 2.

As shown in FIG. 3, the surfaces of the two adjacent third projections 213 close to each other are each provided with the first stop portion 2131. For example, the first stop portion 2131 is arranged at a free end of the third projection 213, and the first stop portion 2131 and the third projection 213 are integrally formed. The spacing between the two adjacent first stop portions 2131 is smaller than the width of the transverse section 53, where the spacing between the two adjacent first stop portions 2131 refers to the minimum distance between the two adjacent first stop portions 2131, and the width of the transverse section 53 refers to the width of the transverse section 53 along an arrangement direction of the two adjacent third projections 213. When the minimum distance is smaller than the width of the transverse section 53, the first stop portion 2131 can abut against the transverse section 53 to limit the movement of the high-current carrier 5 in the direction perpendicular to the axis of the second housing 2.

As shown in FIG. 10, the first connection section 51 and the second connection section 52 are both connected to a circuit board 6. The first stop portion 2131 limits the high-current carrier 5, so as to prevent the first connection section 51 and the second connection section 52 from being separated from the circuit board 6, thereby ensuring good contact between the high-current carrier 5 and the circuit board 6.

As shown in FIGS. 4 and 6, a second stop portion 2132 is arranged between the two adjacent third projections 213, and the transverse section 53 has a limiting surface that can abut against the second stop portion 2132 to limit the movement of the high-current carrier 5 in a direction parallel to the axis of the second housing 2.

After the transverse section 53 is installed in the first socket 22, the transverse section 53 abuts against the second stop portion 2132 through the limiting surface, which can limit the movement of the high-current carrier 5 in the direction parallel to the axis of the second housing 2, thereby ensuring that positions of the first connection section 51 and the second connection section 52 are fixed with respect to the second housing 2. When the first connection section 51 and the second connection section 52 are inserted with the circuit board 6, there is no need to adjust the positions of the first connection section 51 and the second connection section 52, thereby improving the installation efficiency.

In an embodiment, a material of the high-current carrier 5 is copper.

There are many types of high-current carriers 5. For example, the high-current carrier 5 can be a copper bar or a copper wire. The number of high-current carriers 5 can be one, two, or three or more to meet different current detection requirements.

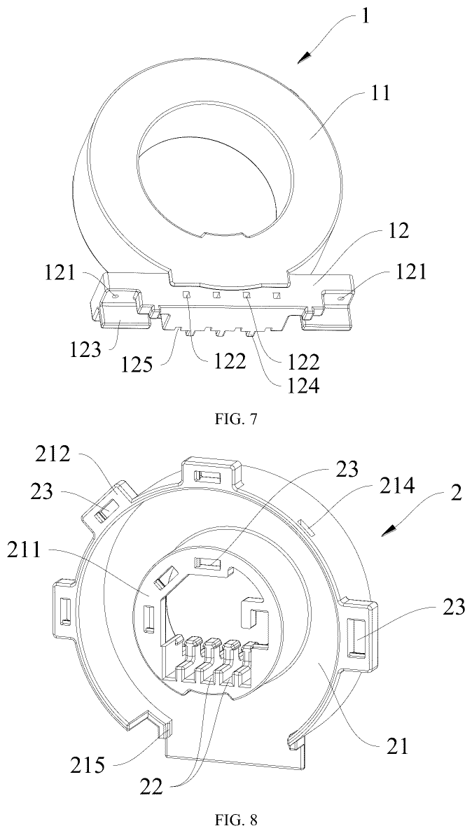

As shown in FIGS. 4 and 7, the first pin socket 121 is a blind hole arranged on a side of the insertion base 12 away from the body 11, and a pin 4 inserted into the first pin socket 121 is a straight pin, an extension direction of which is consistent with an extension direction of the first connection section 51.

As shown in FIG. 7, the number of first pin sockets 121 is at least two, and the number of second pin sockets 122 is at least two; the insertion base 12 is provided with a first partition 123 and a second partition 124, the first partition 123 is arranged between two first pin sockets 121, and is used to increase a distance between the two first pin sockets 121 to ensure the insulation between pins 4 in the two adjacent first pin sockets 121, and the second partition 124 is arranged between two second pin sockets 122, and is used to increase a distance between two second pin sockets 122 to ensure the spacing between pins 4 in the two adjacent second pin sockets 122.

In some other embodiments, as shown in FIG. 11, for a vertical magnetic component, the first projection 211 may be arranged only on the inside surface of the second housing 2, which can reduce the overall size of the magnetic component.

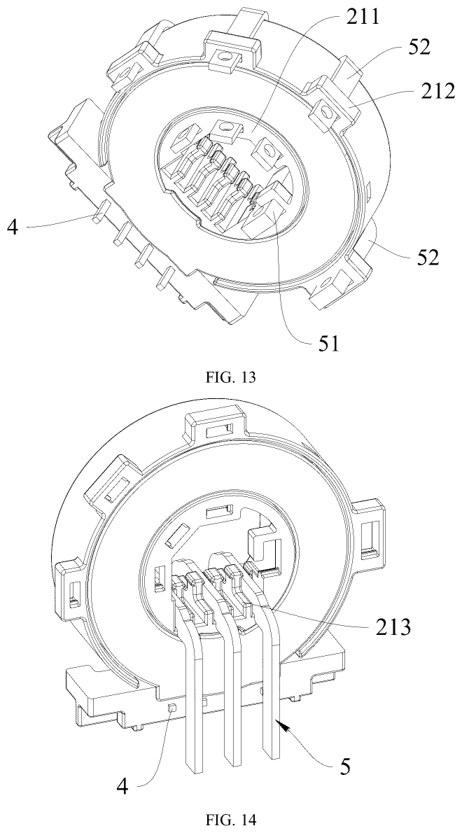

In an embodiment, referring to FIGS. 8 and 13, an outside surface of the second housing 2 is provided with a second projection 212; a part of second sockets 23 is arranged in the first projection 211, and another part of second sockets 23 is arranged in the second projection 212.

For a horizontal magnetic component, the pin 4 is inserted into the second pin socket 122, and the high-current carrier 5 is installed in the second socket 23. In this case, the high-current carrier 5 needs to pass through both second sockets 23 on the first projection 211 and the second projection 212.

In general, during production and processing, the second sockets 23 on the first projection 211 and the second projection 212 are formed simultaneously by means of an injection mold. When a vertical magnetic component is produced, if it is necessary to reduce the overall size of the magnetic component, an insert can be added to the corresponding position of the mold, so that the second projection 212 is not formed on the outside surface of the second housing 2. For example, an insert (a core filled in a cavity forming the second projection 212) is placed in a position corresponding to the second projection 212 in the cavity of the injection mold. During injection molding, the injection molding material will not flow into the cavity forming the second protrusion. Therefore, after demolding, the second projection 212 will not be formed at the position corresponding to the insert.

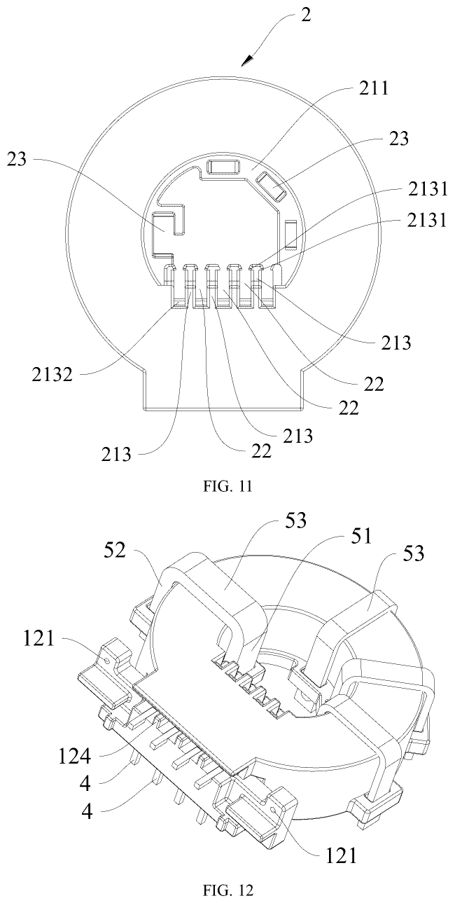

As shown in FIG. 12, the high-current carrier 5 further includes a transverse section 53, and the connection section includes a first connection section 51 and a second connection section 52. The first connection section 51 is connected to an end of the transverse section 53, and the second connection section 52 is connected to the other end of the transverse section 53. The first connection section 51 is inserted into the second socket 23 in the first projection 211, and the second connection section 52 is inserted into the second socket 23 in the second projection 212.

For example, the high-current carrier 5 in the horizontal magnetic component is in a U-shaped bent plate structure.

For a horizontal magnetic component, the axis of the magnetic core assembly 3 is perpendicular to a board surface of the circuit board 6, the first connection section 51 is inserted into the second socket 23 in the first projection 211, and the second connection section 52 is inserted into the second socket 23 in the second projection 212, and then the first connection section 51 and the second connection section 52 are both connected to the circuit board 6.

Referring to FIGS. 7 and 12, the second pin socket 122 is a through hole arranged in the insertion base 12, and the pin 4 inserted into the second pin socket 122 is a right-angle pin.

Referring to FIGS. 7, 9 and 12, the insertion base 12 is provided with an accommodation groove 125, and an extension direction of the accommodation groove 125 is perpendicular to an extension direction of the through hole. An end of the accommodation groove 125 passes through a surface of the insertion base 12 away from the body 11, and the other end of the accommodation groove 125 is in communication with the through hole. The right-angle pin includes a first pin section and a second pin section. For example, the first pin section and the second pin section are integrally formed, the first pin section is perpendicular to the second pin section, the first pin section is penetrated through the through hole, and at least part of the second pin section is limited in the accommodation groove 125.

By providing the accommodation groove 125, at least part of the second pin section is limited in the accommodation groove 125, so that the position of the second pin section can be fixed, the shaking of the right-angle pin is reduced, and the connection stability between the right-angle pin and the circuit board 6 is ensured. For example, referring to FIG. 12, the first pin section, the first connection section 51 and the second connection section 52 are connected to the circuit board.

In addition to the above-mentioned vertical and horizontal installation modes, the magnetic component provided in embodiments of the present disclosure can also realize at least two installation methods: vertical-to-horizontal and horizontal-to-vertical. In some embodiments, the magnetic component is a current transformer, the primary winding of the current transformer is vertical installation mode, and the secondary winding of the current transformer is horizontal installation mode. In other embodiments, the primary winding of the current transformer is horizontal installation mode, and the secondary winding of the current transformer is vertical installation mode.

Referring to FIG. 14, the pin 4 is inserted into the second pin socket 122, and the high-current carrier 5 is installed in the first socket 22 to form a vertical-to-horizontal magnetic component.

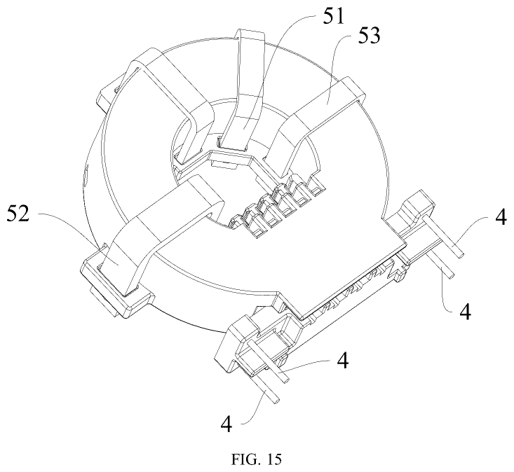

Referring to FIG. 15, the pin 4 is inserted into the first pin socket 121, and the high-current carrier 5 is installed in the second socket 23 to form a horizontal-to-vertical magnetic component.

During the use, two circuit boards may be used, which are named a first circuit board and a second circuit board, respectively. The high-current carrier 5 can be installed on the first circuit board, a pad is arranged on the second circuit board, the second circuit board is installed on the first circuit board, and the pin 4 is connected to the second circuit board, so that the vertical-to-horizontal installation mode and the horizontal-to-vertical installation mode can be realized.

Finally, it should be noted that the above various embodiments are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or replace some or all of the technical features therein by equivalents, and these modifications or replacements do not cause the essence of the corresponding technical solutions to deviate from the scope of the technical solutions of embodiments of the present disclosure.

What is claimed is:

1. A magnetic component, comprising:
a first housing, wherein the first housing is in a hollow structure and is provided with a first pin socket and a second pin socket, an extension direction of the first pin socket is perpendicular to an axis of the first housing, and an extension direction of the second pin socket is parallel to the axis of the first housing;
a second housing, snap-fitted with the first housing to form an installation space and provided with a first socket and a second socket;
a magnetic core assembly, installed in the installation space;
a pin, connected to a leading wire of the magnetic core assembly, arranged in the first pin socket, or arranged in the second pin socket; and
a high-current carrier, penetrated through the second housing, and comprising an connection section configured to be connected with a circuit board, wherein the high-current carrier is arranged in the first socket to make the connection section perpendicular to an axis of the installation space, or the high-current carrier is arranged in the second socket to make the connection section parallel to the axis of the installation space.

2. The magnetic component according to claim 1, wherein the second housing is fitted over an outside of the first housing, an inside surface of the second housing is provided with a first projection, the number of second sockets is more than one, and at least part of the second sockets are arranged in the first projection.

3. The magnetic component according to claim 2, wherein an outside surface of the second housing is provided with a second projection, a part of the second sockets is arranged in the first projection, and the other part of the second sockets is arranged in the second projection.

4. The magnetic component according to claim 3, wherein:
the high-current carrier further comprises a transverse section;
the connection section comprises a first connection section and a second connection section, the first connection section is connected to an end of the transverse section, and the second connection section is connected to the other end of the transverse section; and
the first connection section is inserted into the second socket in the first projection, and the second connection section is inserted into the second socket in the second projection.

5. The magnetic component according to claim 1, wherein the second housing is in the hollow structure, an inside surface of the second housing is provided with a plurality of third projections spaced apart in a direction perpendicular to an axis of the second housing, and the first socket is formed by a space between two adjacent third projections.

6. The magnetic component according to claim 5, wherein:
the high-current carrier further comprises a transverse section connected to the connection section and snapped in the first socket;
surfaces of the two adjacent third projections close to each other are each provided with a first stop portion, and a spacing between two adjacent first stop portions is smaller than a width of the transverse section; and
the first stop portion is capable of being abutted against the transverse section to limit movement of the high-current carrier in the direction perpendicular to the axis of the second housing.

7. The magnetic component according to claim 6, wherein a second stop portion is arranged between the two adjacent third projections, the transverse section is provided with a limiting surface, and the limiting surface is capable of being abutted against the second stop portion to limit movement of the high-current carrier in a direction parallel to the axis of the second housing.

8. The magnetic component according to claim 1, wherein the first housing comprises a body and an insertion base, the insertion base is integrally formed with an outer wall of the body, and the first pin socket and the second pin socket are both arranged in the insertion base.

9. The magnetic component according to claim 8, wherein the first pin socket is a blind hole arranged on a side of the insertion base away from the body, and a pin inserted into the first pin socket is a straight pin.

10. The magnetic component according to claim 8, wherein the second pin socket is a through hole arranged in the insertion base, and a pin inserted into the second pin socket is a right-angle pin.

11. The magnetic component according to claim 10, wherein:
the insertion base is provided with an accommodation groove, an extension direction of the accommodation groove is perpendicular to an extension direction of the through hole, a surface of the insertion base away from the body is penetrated by an end of the accommodation groove, and the other end of the accommodation groove is in communication with the through hole; and
the right-angle pin comprises a first pin section and a second pin section perpendicular to each other, the first pin section is penetrated through the through hole, and at least part of the second pin section is limited in the accommodation groove.

12. The magnetic component according to claim 8, wherein:
the number of first pin sockets is at least two, and the number of second pin sockets is at least two; and
the insertion base is provided with a first partition and a second partition, the first partition is arranged between two first pin sockets, and the second partition is arranged between two second pin sockets.

13. The magnetic component according to claim 1, wherein:
the first housing is provided with a first groove, the magnetic core assembly is arranged in the first groove, and an outer wall of the first groove is provided with a snap-fitting portion; and
the second housing is provided with a second groove, an outer wall of the second groove is provided with a snap-fitting mating portion, and the snap-fitting mating portion is in cooperation with the snap-fitting portion to make two groove walls of the first groove be limited in the second groove in a fixed manner.

14. The magnetic component according to claim 13, wherein one of the snap-fitting portion and the snap-fitting mating portion is a protruding portion, and the other is a recessed portion.

15. The magnetic component according to claim 14, wherein:
the snap-fitting portion comprises a first protruding portion and a first recessed portion, and the snap-fitting mating portion comprises a second recessed portion and a second protruding portion; and
the second recessed portion is snapped with the first protruding portion, and the second protruding portion is snapped with the first recessed portion.

16. The magnetic component according to claim 15, wherein:
the first protruding portion is a bump arranged on a side of the outer wall of the first groove close to a groove bottom, and the second recessed portion is a locking hole arranged on the outer wall of the second groove; and
the second protruding portion is a rib arranged on the outer wall of the second groove, and the first recessed portion is a locking groove arranged on a side of the outer wall of the first groove close to a groove opening.

17. The magnetic component according to claim 1, wherein the magnetic core assembly comprises a magnetic core and a coil winding wound on the magnetic core, and the leading wire of the coil winding is connected to the pin.

18. The magnetic component according to claim 1, wherein the first housing and the second housing are respectively formed by injection molding.

19. The magnetic component according to claim 1, wherein the high-current carrier is made of copper.

20. The magnetic component according to claim 1, wherein the magnetic component is a current transformer.
